(19) United States
(12) Patent Application Publication
(10) Pub. No.: US 2018/0004431 A1
(43) Pub. Date: Jan. 4, 2018

(54) NON-TRANSITORY COMPUTER-READABLE RECORDING MEDIUM RECODING LOG OBTAINING PROGRAM, LOG OBTAINING DEVICE, AND LOG OBTAINING METHOD

(71) Applicant: FUJITSU LIMITED, Kawasaki-shi (JP)

(72) Inventors: Tetsuhiro Yamaguchi, Yokohama (JP); Hitoshi Oda, Kawasaki (JP)

(73) Assignee: FUJITSU LIMITED, Kawasaki-shi (JP)

(21) Appl. No.: 15/607,792

(22) Filed: May 30, 2017

(30) Foreign Application Priority Data
Jul. 1, 2016 (JP) 2016-131932

(51) Int. Cl. G06F 3/06; G06F 17/30

(52) U.S. Cl. CPC G06F 3/0611; G06F 17/30566

(57) ABSTRACT

A non-transitory computer-readable recording medium recoding a log obtaining program that causes a computer to execute processing, the processing includes: obtaining first log data including request source identification information which is used for identifying a request, a response time period related to the request, and a first log record time, from among a plurality of log data included in an access log recorded in a storage; extracting second log data including a second log record time corresponding to a time that is early by the response time period as compared with the first log record time included in the first log data, from among the plurality of log data; and obtaining third log data including the request source identification included in the first log data from among the second log data.

### CROSS-REFERENCE TO RELATED APPLICATION

This application is based upon and claims the benefit of priority of the prior Japanese Patent Application No. 2016-131932, filed on Jul. 1, 2016, the entire contents of which are incorporated herein by reference.

### FIELD

The embodiments discussed herein are related to a computer-readable recording medium recoding a log obtaining program, a log obtaining device, and a log obtaining method.

### BACKGROUND

A plurality of log data recorded in a transaction log for each tenant is provided on a cloud system.

As a related art, Japanese National Publication of International Patent Application No. 2014-502767 is discussed.

### SUMMARY

According to an aspect of the embodiments, a non-transitory computer-readable recording medium recoding a log obtaining program that causes a computer to execute processing, the processing includes: obtaining first log data including request source identification information which is used for identifying a request, a response time period related to the request, and a first log record time, from among a plurality of log data included in an access log recorded in a storage; extracting second log data including a second log record time corresponding to a time that is early by the response time period as compared with the first log record time included in the first log data, from among the plurality of log data; and obtaining third log data including the request source identification included in the first log data from among the second log data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example of a block illustrating obtaining processing of an access log;

FIG. 2 is an example of a block illustrating obtaining processing of an access log;

FIG. 3 illustrates a configuration of a log obtaining system;

FIG. 4 is an example of a functional block illustrating a log obtaining device;

FIG. 5 is an example of a log storage destination table;

FIG. 6 is an example of an IP address of each device;

FIG. 7 is an example of a data table;

FIG. 8 is an example of a flag table;

FIG. 9 is an example of an access log;

FIG. 10 is an example of an access log;

FIG. 11 is an example of transmission log data;

FIG. 12 is an example of transmission log data;

FIG. 13 is an example of a configuration illustrating a computer; and

FIG. 14 is an example of log obtaining processing.

### DESCRIPTION OF EMBODIMENTS

For example, from among a plurality of log data recorded in a transaction log for each tenant, specific log data is obtained using request identification information by which a request of a transaction ID or the like is identified. The obtained log data is written to a log database for each of the tenants.

For example, an access log stored in a storage unit of a device in a system is obtained and analyzed. For example, log data included in the access log are analyzed and cyber attack or the like on the system is detected.

For obtaining processing in which specific log data such as log data including request identification information is obtained from an access log in which a huge amount of log data is recorded, a relatively long time is taken. Due to the time taken for the obtaining processing, real-time performance of log data analysis may be reduced.

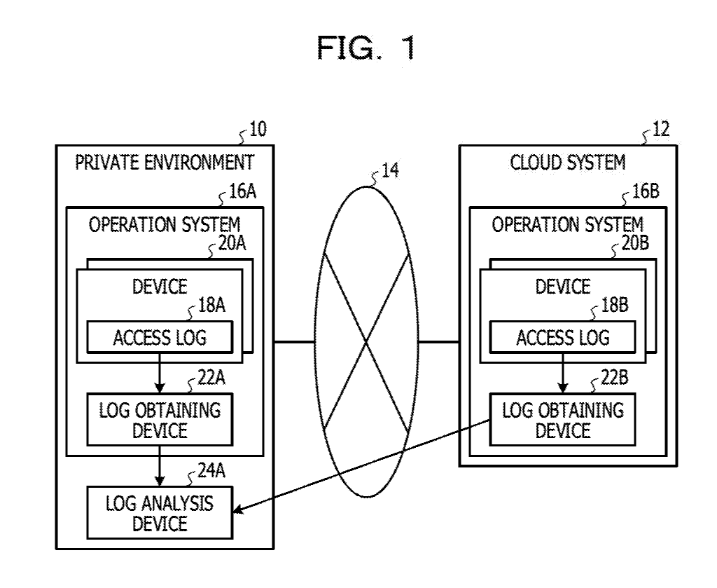

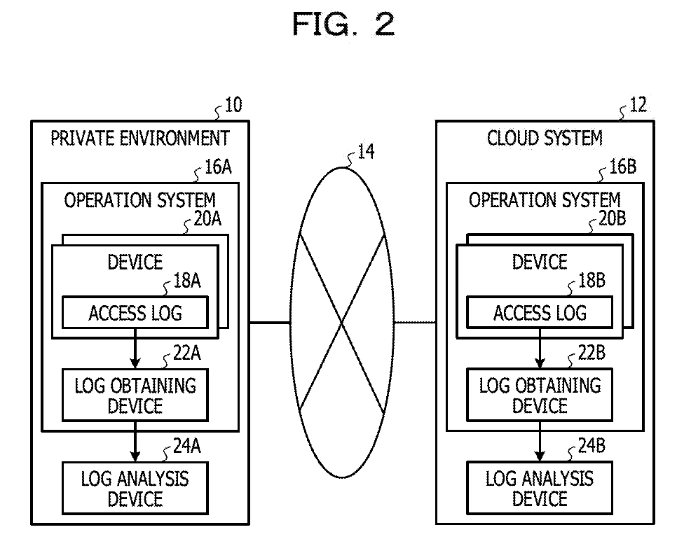

FIGS. 1 and 2 illustrate examples of blocks to explain obtaining processing of an access log. In FIG. 1, as an example, an environment is illustrated in which a private environment 10 and a cloud system 12 such as a public cloud are coupled to each other through a network 14 such as the Internet. The private environment may include, for example, environments such as an on-premise and a private cloud.

As illustrated in FIG. 1, in the private environment 10, an operation system 16A is built. The operation system 16A includes a plurality of devices 20A each of which includes a storage unit that stores an access log 18A, and a log obtaining device 22A that obtains the access log 18A. As the devices 20A, for example, a load balancer (LB), a firewall (FW), a server computer, a virtual machine, or the like, may be used. In the private environment 10, a log analysis device 24A is provided in addition to the operation system 16A.

In the cloud system 12, an operation system 16B is built. The operation system 16B includes a plurality of devices 20B each of which includes a storage unit that stores an access log 18B, and a log obtaining device 22B that obtains the access log 18B, similar to the operation system 16A of the private environment 10. In the following description, the alphabets at the ends of the symbols are omitted when elements are collectively referred to without distinction between the operation systems 16A and 16B, the access logs 18A and 18B, the devices 20A and 20B, and the log obtaining devices 22A and 22B.

When an access log 18 is analyzed by the log analysis device 24A to analyze an access to the operation system 16, an access log 18B is obtained from the device 20B by the log obtaining device 22B, and transmitted to the log analysis device 24A through the network 14. For example, in the network 14 such as the Internet, the transfer speed is slow as compared with an internal network of the private environment 10 such as a local area network (LAN), and a relatively long time is taken for transmission of the access log 18B. Therefore, the real-time performance of analysis of the access log 18 by the log analysis device 24A may be reduced.

For example, there is a case in which pay-per-use in accordance with a transfer amount of data is performed in the cloud system 12 such as a public cloud. In this case, as a transfer amount of data of the access log 18B transmitted from the cloud system 12 to the private environment 10 through the network 14 becomes larger, the cost becomes higher.

For example, when the type, the range, and the like, of the access log 18B that is a collection target are limited, the transfer amount of the access log 18B from the cloud system 12 to the private environment 10 may be reduced. For example, in such a method, when cyber attack is performed on a device 20B that is not the collection target of the access log 18B, the cyber attack may not be detected, and the effect of the cyber attack may not be analyzed.

For example, as illustrated in FIG. 2, when a log analysis device 24B similar to the log analysis device 24A is provided in the cloud system 12, a transfer amount of the access log 18B from the cloud system 12 to the private environment 10 may be reduced. For example, in such a method, the two log analysis devices 24 are provided and, therefore, the cost may increase. For example, when the log analysis device 24 is a hardware appliance product, or when the performance of a virtual machine usable in the public cloud does not satisfy the performance requirement of the log analysis device 24, such a method is not applied.

For example, when the obtaining range of log data is limited from a plurality of log data included in an access log based on response time periods included in the log data, an obtaining time period of the log data may be reduced.

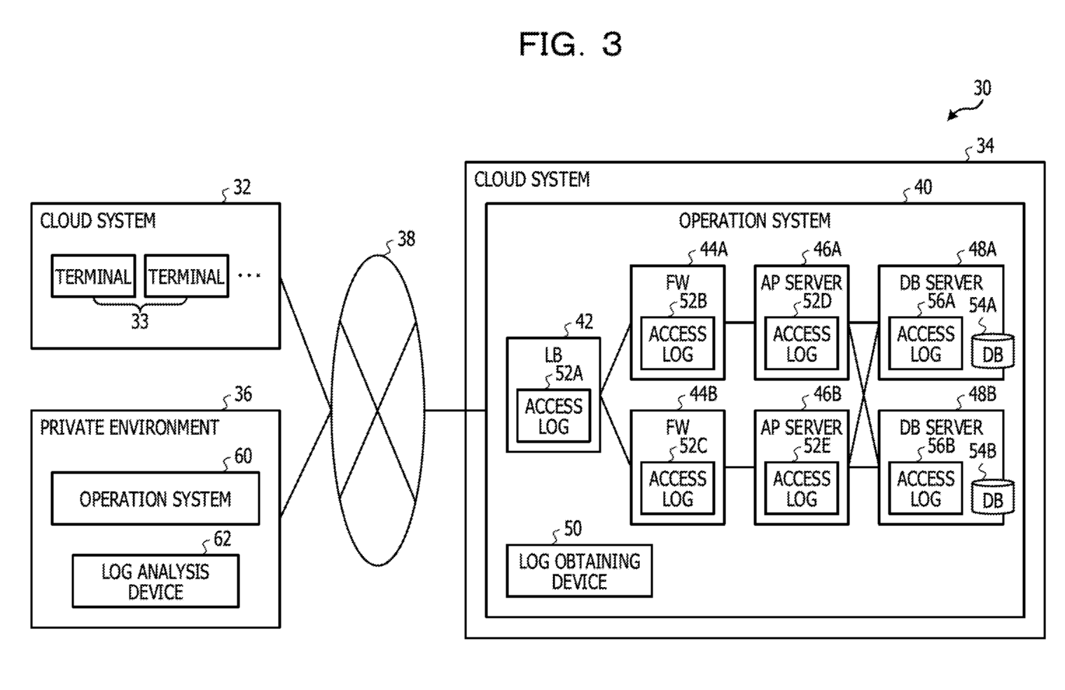

FIG. 3 illustrates an example of a configuration of a log obtaining system. As illustrated in FIG. 3, a log obtaining system 30 includes a client environment 32, a cloud system 34, and a private environment 36. Devices provided in the client environment 32, the cloud system 34, and the private environment 36 are coupled to each other and able to communicate with each other through a network 38 such as the Internet.

In the client environment 32, a plurality of client terminals 33 (hereinafter simply referred to as “terminals 33”) is provided.

In the cloud system 34, an operation system 40 is built. The operation system 40 includes an LB 42, FWs 44A and 44B, application (AP) servers 46A and 46B, database (DB) servers 48A and 48B, and a log obtaining device 50. In the following description, the alphabets at the ends of the symbols are omitted when elements are collectively referred to without distinction between the FWs 44A and 44B, the AP servers 46A and 46B, and the DB servers 48A and 48B. Between the devices of the LB 42, the FW 44, the AP server 46, the DB server 48, and the log obtaining device 50, the times of the devices may be synchronized using a network time protocol (NTP) or the like.

The LB 42 distributes the load on the FW 44, the AP server 46, and the DB server 48 due to an access from the outside of the operation system 40, such as the terminal 33. A certain storage area of a storage unit included in the LB 42 stores an access log 52A in which log data indicating an access to the LB 42 is recorded.

In accordance with a set rule, through the FW 44, inbound and outbound communications are caused to pass and are blocked. Certain storage areas of storage units included in the FWs 44A and 44B respectively store access logs 52B and 52C in which log data indicating accesses to the FWs 44A and 44B are recorded.

In the AP servers 46, web applications that respectively access DBs 54A and 54B operate, for example, on a web application server program. Certain storage areas of storage units included in the AP servers 46A and 46B respectively store access logs 52D and 52E in which log data indicating accesses to the AP servers 46A and 46B are recorded.

Certain storage areas of storage units included in the DB servers 48A and 48B respectively store the DBs 54A and 54B that store various data including specific data defined in advance as important data (hereinafter referred to as “important data”). The certain storage areas of the storage units respectively store access logs 56A and 56B in which log data indicating accesses to the DBs 54A and 54B are recorded.

In the following description, the alphabets at the ends of the symbols are omitted when elements are collectively referred to without distinction between the access logs 52A, 52B, 52C, 52D, and 52E, the DBs 54A and 54B, and the access logs 56A and 56B.

The LB 42 and each of the FWs 44A and 44B are coupled to each other through a network such as a LAN and able to communicate with each other. The FW 44A and the AP server 46A are coupled to each other through the network and able to communicate with each other. The FW 44B and the AP server 46B are coupled to each other through the network and able to communicate with each other. The AP servers 46A and 46B and the DB servers 48A and 48B are coupled to each other through the network and able to communicate with each other.

The log obtaining device 50 is coupled to the network and able to obtain the access log 52 and the access log 56. The log obtaining device 50 obtains specific log data from the access log 52 and the access log 56 and transmits the obtained log data to a log analysis device 62 through the network 38. The number of LBs 42, FWs 44, AP servers 46, DB servers 48, and log obtaining devices 50 and the connection configuration are examples, and are not limited to the example of FIG. 3.

In the private environment 36, an operation system 60 similar to the operation system 40 of the cloud system 34 is built. In the private environment 36, the log analysis device 62 is provided that receives the specific log data transmitted from the log obtaining device 50 and analyzes the received log data.

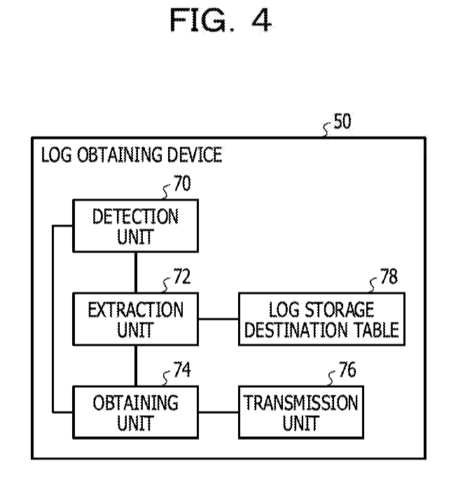

FIG. 4 illustrates an example of a functional block of the log obtaining device. As illustrated in FIG. 4, the log obtaining device 50 includes a detection unit 70, an extraction unit 72, an obtaining unit 74, and a transmission unit 76. In addition, a certain storage area of the log obtaining device 50 stores a log storage destination table 78.

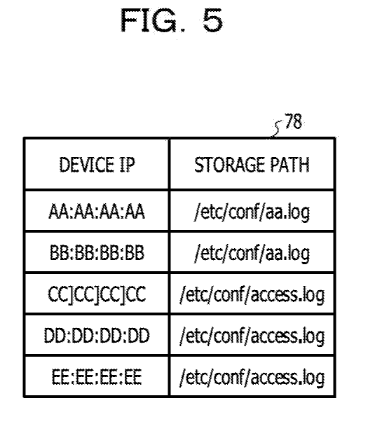

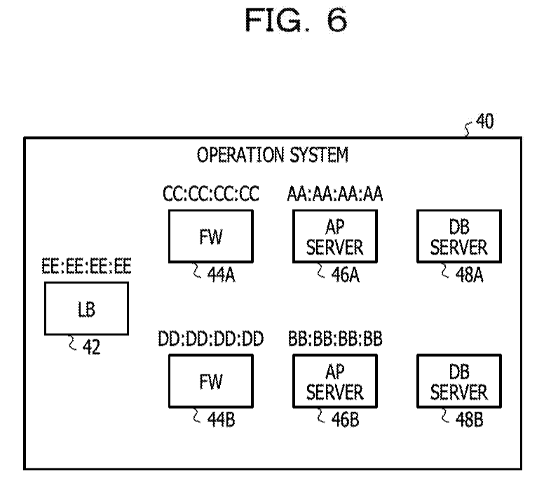

FIG. 5 illustrates an example of the log storage destination table. As illustrated in FIG. 5, the log storage destination table 78 stores a “device IP” and a “storage path”. The “device IP” stores an IP address of a device in which the access log 52 or the access log 56 is stored in the operation system 40. The “storage path” stores a path of a storage destination of the access log. FIG. 6 illustrates an example of an IP address of each of the devices. As an example, as illustrated in FIG. 6, the IP address of the AP server 46A is “AA:AA:AA:AA”, and the IP address of the AP server 46B is “BB:BB:BB:BB”. The IP address of the FW 44A is “CC:CC:CC:CC”, and the IP address of the FW 44B is “DD:DD:DD:DD”. The IP address of the LB 42 is “EE:EE:EE:EE”.

For example, in the example of FIG. 5, it is indicated that the access log 52D of the AP server 46A the IP address of which is “AA:AA:AA:AA” is stored in “/etc/conf/aa.log”.

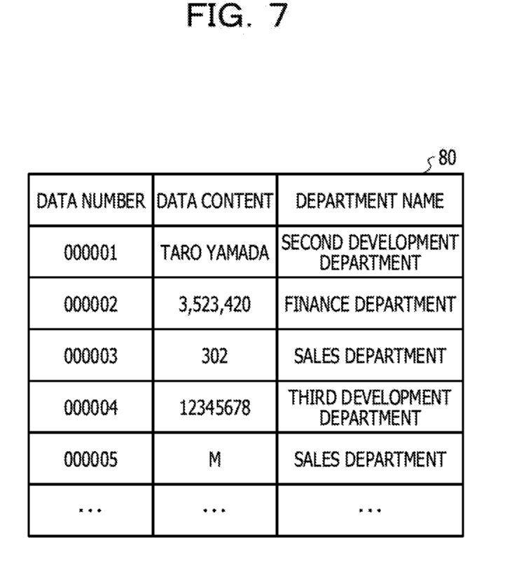

The detection unit 70 detects an access to important data stored in the DB 54, based on the access log 56 and data stored in the DB 54. Detection processing in which an access to the important data is detected by the detection unit 70 is described with reference to FIGS. 7 to 9.

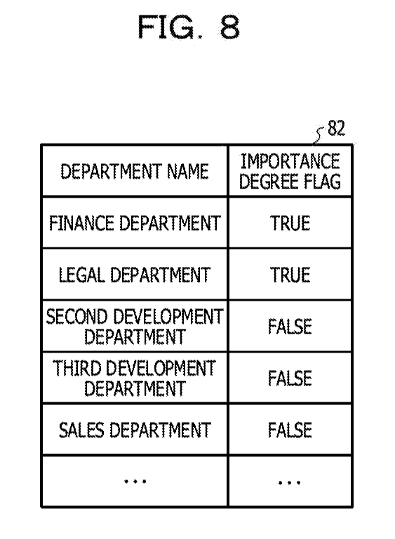

FIG. 7 illustrates an example of a data table. FIG. 8 illustrates an example of a flag table. The tables illustrated in FIGS. 7 and 8 may be stored in the DB 54. As illustrated in FIG. 7, a data table 80 stores a “data number”, a “data content”, and a “department name”. The “data number” stores a number by which each data is uniquely identified. The “data content” stores a content of the data. The “department name” stores the name of a department that handles the content of the data stored in the “data content”.

As illustrated in FIG. 8, a flag table 82 stores a “department name” and an “importance degree flag”. The “department name” of the flag table 82 stores information similar to the “department name” of the data table 80. The “importance degree flag” stores information indicating whether the content of data handled by the department stored in the “department name” is important. For example, data handled by a department in the “department name” in which the “importance degree flag” indicates “True” may be important data, and data handled by a department in the “department name” in which the “importance degree flag” indicates “False” may be unimportant data. For example, in FIGS. 7 and 8, data the data number of which is “000002” may be important data.

For example, the important data includes data set by the user as data that is an analysis target of an access log. Determination of whether the data is important data based on a department name is an example, and the embodiment is not limited to such an example.

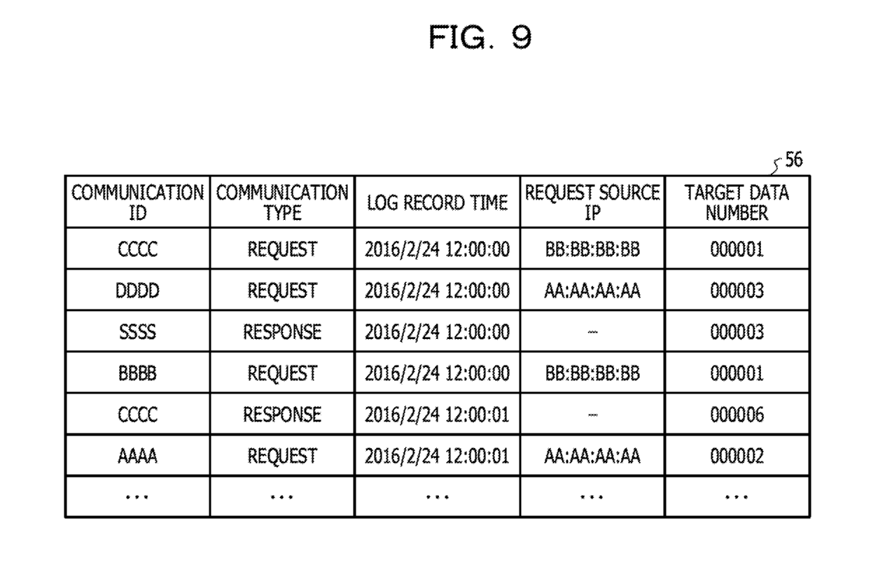

FIG. 9 illustrates an example of an access log. FIG. 9 illustrates an example of an access log 56 in a format in which information used for the above-described detection processing is normalized in order to avoid complication. As illustrated in FIG. 9, the access log 56 records a “communication ID”, a “communication type”, a “log record time”, a “request source IP”, and a “target data number”.

The “communication ID” stores request identification information by which a request from the outside of the operation system 40 such as the terminal 33 is uniquely identified. The same “communication ID” is stored in the access log 52 and the access log 56 for a series of communications from a request to a response to the terminal 33, for example, when the request from the terminal 33 to the operation system 40 is issued.

For example, the “communication type” stores whether the communication type is “Request” or “Response”. The “log record time” stores a date and time at which log data corresponding to “request” or “response” is recorded in the access log 56 after the occurrence of the “request” or “response”. For example, in the “log record time”, merely a time may be stored.

The “request source IP” stores an IP address of a device that is a request source when the communication type is “Request”. The “target data number” stores a data number of accessed data of the data table 80.

The detection unit 70 periodically refers to the access log 56, and obtains a target data number of log data the communication type of which is “Request” when the log data is recorded in the access log 56. The detection unit 70 refers to the data table 80, and obtains a department name having a data number corresponding to the obtained target data number. The detection unit 70 refers to the flag table 82, and detects whether access to important data has been made depending on whether the importance degree flag having a department name corresponding to the obtained department name is “True”.

When the detection unit 70 detects that access to important data has been made, the detection unit 70 outputs log data corresponding to the access recorded in the access log 56 to the extraction unit 72 and the obtaining unit 74. For example, in FIG. 9, the detection unit 70 outputs log data the communication ID of which is “AAAA”, to the extraction unit 72 and the obtaining unit 74.

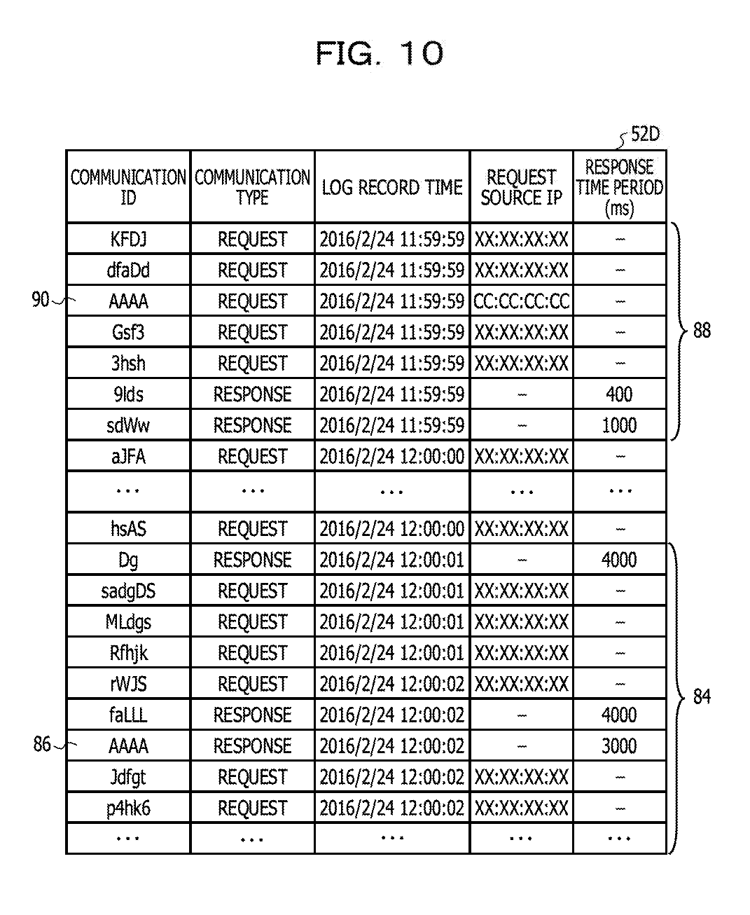

When the log data is input to the extraction unit 72 from the detection unit 70, the extraction unit 72 refers to the log storage destination table 78, and obtains an access log 52 stored in a storage path corresponding to a request source IP of the log data from a device indicated by the request source IP. The extraction unit 72 extracts log data from the obtained access log 52, based on a log record time of the log data input from the detection unit 70. Extraction processing of log data by the extraction unit 72 is described below with reference to FIG. 10.

FIG. 10 illustrates an example of an access log. FIG. 10 illustrates an example of an access log 52D in a format in which information used for the above-described extraction processing is normalized, in order to avoid complication. As illustrated in FIG. 10, the access log 52D stores a “communication ID”, a “communication type”, a “log record time”, a “request source IP”, and a “response time period”. In FIG. 10, an example of the access log 52D is illustrated, but log data similar to the access log 52D may also be stored in the access logs 52A to 52C, and 52E.

The “communication ID”, the “communication type”, the “log record time”, and the “request source IP” respectively store information similar to the “communication ID”, the “communication type”, the “log record time”, and the “request source IP” of the access log 56. The “response time period” stores a time taken from the request to the response.

The extraction unit 72 identifies log data 86 including the same communication ID as the communication ID of the log data input from the detection unit 70, from among log data 84 recorded in the access log 52D on and after the log record time of the input log data. In order to identify a log of a response from the DB server 48, which has been recorded in the access log 52D, as described above, a range in which the log data 86 is identified is limited to the time after the above-described log record time.

The extraction unit 72 extracts log data 88 including a log record time corresponding to a time that is earlier by a response time period included in the identified log data 86 as compared with the log record time included in the log data 86, from among the log data included in the access log 52D.

In FIG. 10, the extraction unit 72 extracts log data 88 recorded at “11:59:59” obtained by subtracting “3000 ms” (=3 seconds) that is the response time period included in the log data 86 from “12:00:02” that is the log record time included in the log data 86.

The obtaining unit 74 obtain log data 90 including the same communication ID as the communication ID included in the log data 86, from among the log data 88 extracted by the extraction unit 72.

The extraction unit 72 obtains an access log 52 stored in a storage path corresponding to a request source IP included in the log data 90 obtained by the obtaining unit 74, from a device of the request source IP to execute the above-described extraction processing. The extraction unit 72 repeats the above-described extraction processing until the access log 52 that is an extraction target becomes the access log 52A of the most upstream device of the communication path, for example, the access log 52A of the LB 42.

Similarly, the obtaining unit 74 repeatedly executing the above-described obtaining processing of the log data 90 for log data 88 repeatedly extracted by the extraction unit 72.

The transmission unit 76 generates transmission log data 92 in which the log data input from the detection unit 70, the log data 86, and the log data 90 are arranged in chronological order, and to which information indicating a device that is an output source of each of the log data has been assigned. The transmission unit 76 transmits the generated transmission log data 92 to the log analysis device 62 through the network 38.

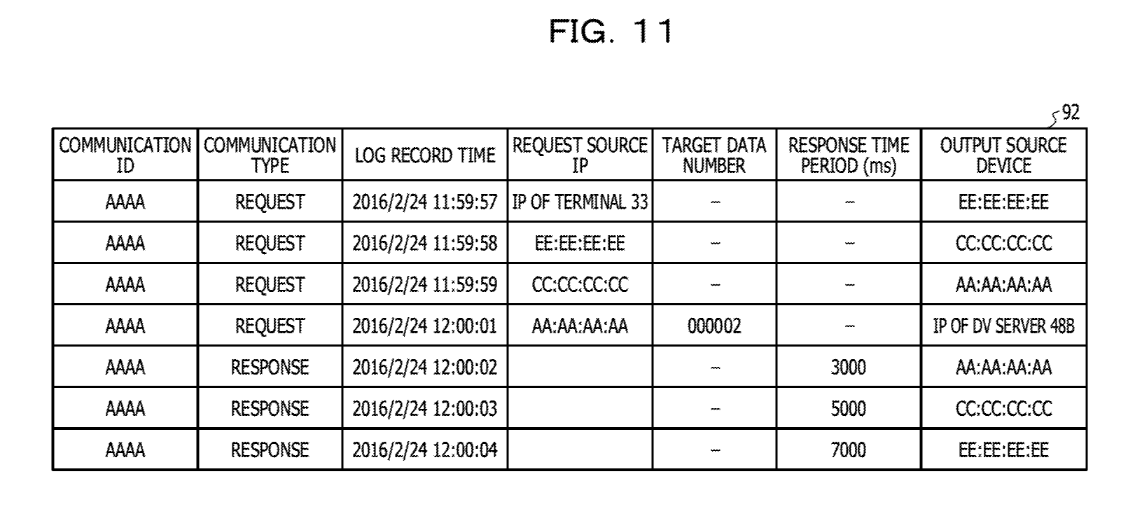

FIG. 11 illustrates an example of the transmission log data. As illustrated in FIG. 11, the transmission log data 92 stores a “communication ID”, a “communication type”, a “log record time”, a “request source IP”, a “target data number”, a “response time period”, and an “output source device”. Each of the “communication ID”, the “communication type”, the “log record time”, the “request source IP”, the “target data number”, and the “response time period” stores information similar to the corresponding information stored in at least one of the access log 52 and the access log 56. The “output source device” stores an IP address of a device that is an output source of each of the log data as information indicating the device that is the output source.

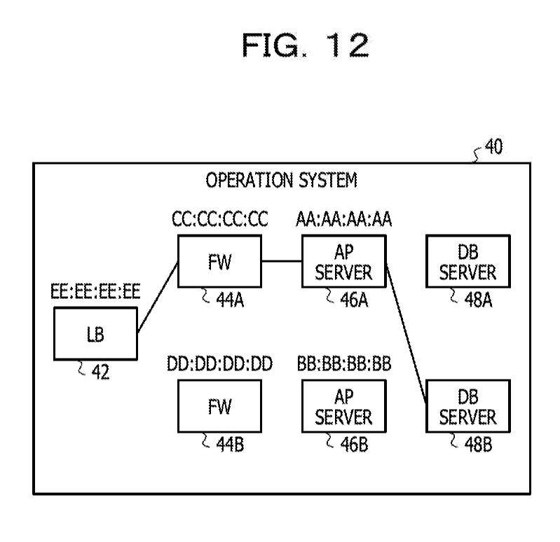

In the example of FIG. 11, the transmission log data 92 stores log data of the request and the response related to a series of the communications of the LB 42, the FW 44A, the AP server 46A, and the DB server 48B provided in the communication path, as illustrated in the example of FIG. 12.

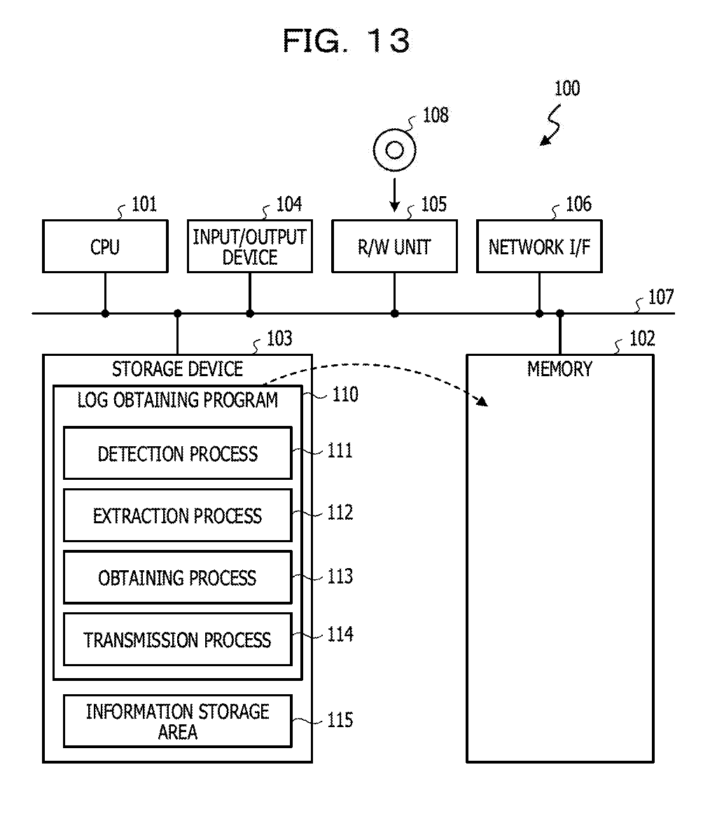

FIG. 13 illustrates an example of a configuration of a computer. The log obtaining device 50 may be obtained, for example, by a computer 100 illustrated in FIG. 13. The computer 100 also includes a central processing unit (CPU) 101, a memory 102 as a temporary storage area, and a nonvolatile storage unit 103. The computer 100 includes an input/output device 104 including a display device and an input device. The computer 100 also includes a read/write (R/W) unit 105 that controls reading and writing of data for a recording medium 108, and a network interface (I/F) 106 coupled to a network. The CPU 101, the memory 102, the storage unit 103, the input/output device 104, the R/W unit 105, and the network I/F 106 are coupled to each other through a bus 107.

The storage unit 103 may be a hard disk drive (HDD), a solid state drive (SSD), a flash memory, or the like. The storage unit 103 as a recording medium stores a log obtaining program 110 that causes the computer 100 to function as the log obtaining device 50. The log obtaining program 110 includes a detection process 111, an extraction process 112, an obtaining process 113, and a transmission process 114. The storage unit 103 includes an information storage area 115 that stores the log storage destination table 78.

The CPU 101 reads the log obtaining program 110 from the storage unit 103, deploys the log obtaining program 110 to the memory 102, and executes the processes included in the log obtaining program 110. When the CPU 101 executes the detection process 111, the CPU 101 operates as the detection unit 70 illustrated in FIG. 4. When the CPU 101 executes the extraction process 112, the CPU 101 operates as the extraction unit 72 illustrated in FIG. 4. When the CPU 101 executes the obtaining process 113, the CPU 101 operates as the obtaining unit 74 illustrated in FIG. 4. When the CPU 101 executes the transmission process 114, the CPU 101 operates as the transmission unit 76 illustrated in FIG. 4. As described above, the computer 100 that has executed the log obtaining program 110 functions as the log obtaining device 50.

A function achieved by the log obtaining program 110 may be executed, for example, by a semiconductor integrated circuit, an application specific integrated circuit (ASIC), or the like.

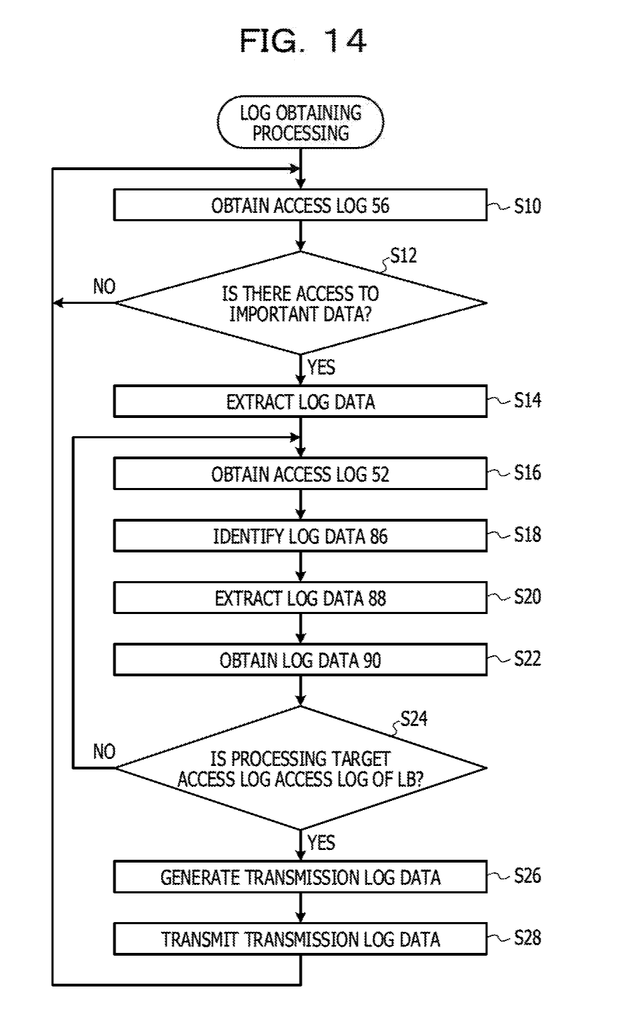

FIG. 14 illustrates an example of log obtaining processing. For example, when the log obtaining device 50 executes the log obtaining program 110, the log obtaining processing illustrated in FIG. 14 is executed. The log obtaining processing illustrated in FIG. 14 is executed by the CPU 101, for example, in a case or the like in which the power source of the log obtaining device 50 is turned on.

In Operation S10 of the log obtaining processing illustrated in FIG. 14, the detection unit 70 obtains an access log 56 from the DB server 48. For example, the detection unit 70 obtains log data that are not obtained since the previous execution of the processing of Operation S10, from among log data recorded in the access log 56.

In Operation S12, the detection unit 70 obtains log data each communication type of which is “Request”, from among the log data obtained in Operation S10. The detection unit 70 determines whether access to important data has been performed, based on the obtained log data, with reference to the data table 80 and the flag table 82. When “NO” is determined in Operation S12, the processing returns to Operation S10, and when “YES” is determined in Operation S12, the processing proceeds to Operation S14.

In Operation S14, the detection unit 70 extracts log data corresponding to the access to the important data, which has been detected in Operation S12, from the log data obtained in Operation S10. In Operation S16, the extraction unit 72 obtains an access log 52 stored in a storage path corresponding to a request source IP included in the log data extracted in Operation S14, from a device indicated by the request source IP, with reference to the log storage destination table 78.

When “NO” is determined in Operation S24, and the second or subsequent Operation S14 is executed, the extraction unit 72 obtains an access log 52 by the following processing. For example, in this case, the extraction unit 72 obtains an access log 52 stored in a storage path corresponding to a request source IP included in log data 90 obtained in Operation S22, from a device indicated by the request source IP, with reference to the log storage destination table 78.

In Operation S18, the extraction unit 72 identifies log data 86, from among log data 84 recorded after the log record time included in the log data extracted in Operation S14, in the access log 52 obtained in Operation S16. When the second or subsequent Operation S18 is executed, log data 86 is identified by the following processing. For example, in this case, the extraction unit 72 identifies log data 86 from among the log data 84 recorded after the log record time included in the log data 86 that had been identified in Operation S18, in the access log 52 obtained in the previous Operation S16.

In Operation S20, the extraction unit 72 extracts log data 88 by the following processing, from among the log data included in the access log 52 obtained in Operation S16. For example, the extraction unit 72 extracts log data 88 including a log record time corresponding to a time that is earlier by a response time period included in the log data 86 identified in Operation S18 as compared with the log record time included in the log data 86, from among the log data included in the access log 52.

In Operation S22, the obtaining unit 74 obtains log data 90 including the same communication ID as the communication ID included in the log data 86 identified in Operation S18, from among the log data 88 executed in Operation S20.

In Operation S24, the obtaining unit 74 determines whether the access log 52 that is a processing target of Operations S16 to S22 is an access log 52 of the LB 42. When “NO” is determined in Operation S24, the processing returns to Operation S16, when “YES” is determined in Operation S24, the processing proceeds to Operation S26.

In Operation S26, the transmission unit 76 generates transmission log data 92 using the log data extracted in Operation S14, the log data 86 identified in Operation S18, and the log data 90 obtained in Operation S22. In Operation S28, the transmission unit 76 transmits the transmission log data 92 generated in Operation S26 to the log analysis device 62 through the network 38. When the processing of Operation S28 ends, the processing returns to Operation S10.

A reduction effect of a transfer amount of log data by the above-described log obtaining processing is calculated. For example, as an example, a case is estimated in which the number of devices in each of which an access log is stored is 100, and the number of requests is 10000 requests/second. For example, as an example, a case is estimated in which the number of devices related to a single request is 10 that corresponds to 10% of the whole number of devices, and the data capacity of one row of log data recorded in the access log is 0.5 Kbit. For example, as an example, a case is estimated in which the number of request for important data is 1 request/second.

The number of rows of log data recorded in the access log within one second is calculated by the following formula (1).

The number of rows of log data=the number of requests/second×the number of servers related to a single request×2(round-trip communication portion) (1)

For example, in the above-described example, the number of rows of the log data is calculated as 200000 rows/second in accordance with the following formula (2).

10000×10×2=200000 (2)

In the above-described example, a transfer amount of log data per second is calculated as 100 Mbit in accordance with the following formula (3).

200000×0.5=100000 (Kbit)=100 (Mbit) (3)

For example, the number of rows of the log data per second, which is obtained in the above-described obtaining processing, is calculated by the following formula (4).

The number of rows of the log data=the number of requests/second for important data×the number of device through which the communication has passed×2(round-trip communication portion) (4)

For example, in the above-described example, the number of rows of the log data is calculated as 20 rows/second, in accordance with the following formula (5).

1×10×2=20 (5)

For example, in the above-described example, a transfer amount of the log data per second is calculated as 10 Kbit/second in accordance with the following formula (6).

20×0.5=10 (6)

As described above, in the system having the scale illustrated in the above-described example, when the above-described method is applied, the transfer amount of the log data may be reduced to 1/1000000, as compared with a case in which transfer of all log data recorded in the access log is performed.

For example, when log data including a communication ID, a response time period, and a log record time is recorded in the access log 52, the following processing may be executed. log data including a log record time corresponding to a time that is earlier by the response time period as compared with the log record time included in the recorded log data are extracted. From among the extracted log data, log data including the communication ID included in the recorded log data is obtained. As described above, the extracted log data is limited to the log data including the log record time corresponding to the time that is earlier by the response time period as compared with the log record time included in the recorded log data, so that a time taken to obtain specific log data from the access log may be reduced. A transfer amount of the log data through the network 14 may be reduced.

When access to important data has been performed, log data including a log record time corresponding to a time that is earlier by a response time period is extracted from among a plurality of log data included in an access log 52 that is a request source for the important data. Therefore, the log data related to communication through which the access to the important data has been performed is obtained.

Log data described below is extracted from among a plurality of log data included in an access log 52 of a device indicated by a request source IP included in the obtained log data. For example, log data including a log record time corresponding to a time that is earlier by a response time period as compared with a log record time of log data that includes a communication ID included in the obtained log data, the response time period, and the log record time are further extracted. From among the extracted log data, log data including the communication ID is obtained. Therefore, the log data related to a series of communications is obtained from the access log 52.

For example, the embodiment is not limited to a case in which the log data 88 are extracted when access to the above-described important data has been performed. For example, when the access log 52 is periodically referred to, and log data including a communication ID, a response time period, and a log record time has been recorded in the access log 52, log data 88 may be extracted.

For example, the embodiment is not limited to the above-described case in which the log obtaining program 110 is stored (installed) in the storage unit 103 in advance. The log obtaining program 110 may be provided in the form of being recorded in a recording medium such as a compact disc-read-only memory (CD-ROM), a digital versatile disc (DVD)-ROM, a universal serial bus (USB) memory, or a memory card.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable recording medium recoding a log obtaining program that causes a computer to execute processing, the processing comprising:
obtaining first log data including request source identification information which is used for identifying a request, a response time period related to the request, and a first log record time, from among a plurality of log data included in an access log recorded in a storage;
extracting second log data including a second log record time corresponding to a time that is early by the response time period as compared with the first log record time included in the first log data, from among the plurality of log data; and
obtaining third log data including the request source identification included in the first log data from among the second log data.

2. The non-transitory computer-readable recording medium according to claim 1, wherein
the second log data is, in an access to specific data, extracted from among the plurality of log data included in the access log stored in the storage of a request source for the specific data.

3. The non-transitory computer-readable recording medium according to claim 2, wherein
a plurality of devices is provided in a communication path to access the specific data from a terminal that transmits a request for the specific data, and each of the plurality of devices includes a storage that stores an access log.

4. The non-transitory computer-readable recording medium according to claim 3, wherein the processing further comprising:
extracting the second log data including a log record time corresponding to a time that is early by the response time period as compared with the log record time from among the log data which includes the request source identification information, the response time period and the log record time of the first log data and is included in the access log stored in the storage of the device corresponding to the request source indicated by the request source identification information included in the first log data.

5. The non-transitory computer-readable recording medium according to claim 4, wherein the processing further comprising:
obtaining the third log data including the request source identification information included in the log data from the second log data.

6. A log obtaining device comprising:
a memory that stores a log obtaining program; and
a processor that executes processing based on the log obtaining program, wherein
the processing includes:
obtaining first log data including request source identification information which is used for identifying a request, a response time period related to the request, and a first log record time, from among a plurality of log data included in an access log recorded in a storage;
extracting second log data including a second log record time corresponding to a time that is early by the response time period as compared with the first log record time included in the first log data, from among the plurality of log data; and
obtaining third log data including the request source identification included in the first log data from among the second log data.

7. The log obtaining device according to claim 6, wherein
the second log data is, in an access to specific data, extracted from among the plurality of log data included in the access log stored in the storage of a request source for the specific data.

8. The log obtaining device according to claim 7, wherein
a plurality of devices is provided in a communication path to access the specific data from a terminal that transmits a request for the specific data, and each of the plurality of devices includes a storage that stores an access log.

9. The log obtaining device according to claim 8, wherein the processing further comprising:
extracting the second log data including a log record time corresponding to a time that is early by the response time period as compared with the log record time from among the log data which includes the request source identification information, the response time period and the log record time of the first log data and is included in the access log stored in the storage of the device corresponding to the request source indicated by the request source identification information included in the first log data.

10. The log obtaining device according to claim 9, wherein the processing further comprising:
obtaining the third log data including the request source identification information included in the log data from the second log data.

11. A log obtaining method, the processing comprising:
obtaining, by a computer, first log data including request source identification information which is used for identifying a request, a response time period related to the request, and a first log record time, from among a plurality of log data included in an access log recorded in a storage;
extracting second log data including a second log record time corresponding to a time that is early by the response time period as compared with the first log record time included in the first log data, from among the plurality of log data; and
obtaining third log data including the request source identification included in the first log data from among the second log data.

12. The log obtaining method according to claim 11, wherein
the second log data is, in an access to specific data, extracted from among the plurality of log data included in the access log stored in the storage of a request source for the specific data.

13. The log obtaining method according to claim 12, wherein
a plurality of devices is provided in a communication path to access the specific data from a terminal that transmits a request for the specific data, and each of the plurality of devices includes a storage that stores an access log.

14. The log obtaining method according to claim 13, wherein the processing further comprising:
extracting the second log data including a log record time corresponding to a time that is early by the response time period as compared with the log record time from among the log data which includes the request source identification information, the response time period and the log record time of the first log data and is included in the access log stored in the storage of the device corresponding to the request source indicated by the request source identification information included in the first log data.

15. The log obtaining method according to claim 14, wherein the processing further comprising:
obtaining the third log data including the request source identification information included in the log data from the second log data.
